(19) United States
(12) Patent Application Publication
(10) Pub. No.: US 2011/0232403 A1
(43) Pub. Date: Sep. 29, 2011

(54) COMPLEX REDUCTION MECHANISM OF LINEAR ACTUATOR

(76) Inventors: Sheng-Yu YU, Taichung City (TW); Chia-Chun Wei, Taichung City (TW)

(21) Appl. No.: 12/748,383

(22) Filed: Mar. 27, 2010

(51) Int. Cl. F16H 1/00; F16H 1/20; F16H 1/28

(52) U.S. Cl. 74/413; 475/343

(57) ABSTRACT

A complex reduction mechanism of linear actuator includes a primary reducing unit and a secondary reducing unit arranged in an axial direction of the primary output shaft. The primary reducing unit includes a primary input shaft, a primary output shaft and a primary reducing set. The primary input shaft is rotationally drivingly coupled with a power output shaft of the power source for transmitting rotational power to the primary reducing set. The primary reducing set reduces the rotational speed and transmits the rotational power to the primary output shaft, which transmits the rotational power outward at lower rotational speed. The secondary reducing unit includes a secondary reducing set and a secondary output section. The secondary reducing set serves to reduce the rotational speed output from the primary output shaft and transmit the rotational power to the secondary output section for driving the actuation shaft to linearly axially reciprocally move.

### BACKGROUND OF THE INVENTION

1. Field of the Invention

The present invention relates generally to a linear actuator, and more particularly to a complex reduction mechanism of linear actuator.

2. Description of the Related Art

Conventional linear actuators are widely and reliably used in various fields such as hospital beds, industrial robotic arms and even daily utilities. The existent linear actuator is drivable by an electrical motor via an appropriate transmission mechanism. The rotational power output from the motor is converted into linear power for driving a shaft to axially linearly reciprocally move. Such linear actuator can exert linear force to, for example, lift/lower a hospital bed or drive a robotic arm.

With the advance of various industrial fields, many advanced linear actuators have been developed to satisfy the demands of the industrial fields. The advanced linear actuators can be operated at different speeds to provide different magnitudes of forces in accordance with different requirements of the industrial fields. In a conventional linear actuator, the transmission mechanism generally includes a reducing device composed of some forward gears. The gears are engaged with each other at a certain gear ratio for reducing the speed. However, the conventional linear actuator has a limited space for installation of the reducing device. Therefore, the conventional linear actuator often simply adopts a one-stage reducing device for reducing the speed. Such one-stage reducing device has a limited reduction ratio mode and is hard to meet the advanced demands of the industrial fields.

### SUMMARY OF THE INVENTION

It is therefore a primary object of the present invention to provide a complex reduction mechanism of linear actuator, which has more reduction ratio modes than prior art to meet actual requirements of the industrial fields.

It is a further object of the present invention to provide the above complex reduction mechanism of linear actuator, which is installed in the linear actuator without increasing the volume of the linear actuator. Therefore, the existence of the complex reduction mechanism of the present invention will not lead to enlargement of the total volume of the linear actuator.

To achieve the above and other objects, the complex reduction mechanism of the linear actuator of the present invention is installed in the linear actuator between a power source and an actuation shaft of the linear actuator. The complex reduction mechanism serves to reduce the rotational speed output from the power source and transmit the rotational power of the power source to the actuation shaft for driving the actuation shaft to linearly axially move. The complex reduction mechanism includes: a primary reducing unit including a primary input shaft, a primary output shaft and a primary reducing set positioned between the primary input shaft and the primary output shaft, the primary input shaft being coupled with a power output shaft of the power source and rotationally drivable by the power source, whereby the primary input shaft can transmit rotational power to the primary reducing set, the primary reducing set serving to reduce the rotational speed and transmit the rotational power to the primary output shaft, whereby the primary output shaft can transmit the rotational power outward at lower rotational speed; and a secondary reducing unit arranged in an axial direction of the primary output shaft, the secondary reducing unit including a secondary reducing set and a secondary output section, the secondary reducing set serving to further reduce the rotational speed output from the primary output shaft and transmit the rotational power to the secondary output section, whereby the second output section can transmit the rotational power at even lower rotational speed to the actuation shaft for driving the actuation shaft to linearly axially reciprocally move.

The present invention can be best understood through the following description and accompanying drawings, wherein:

### BRIEF DESCRIPTION OF THE DRAWINGS

FIG. 1 is a perspective assembled view of a first embodiment of the present invention, which is installed in a linear actuator;

FIG. 2 is a perspective exploded view of the first embodiment of the present invention;

FIG. 3 is a sectional view taken along line a-a of FIG. 1;

FIG. 4 is a sectional view taken along line b-b of FIG. 1;

FIG. 5 is a perspective assembled view of a second embodiment of the present invention, which is installed in a linear actuator; and

FIG. 6 is a sectional view taken along line c-c of FIG. 5.

### DETAILED DESCRIPTION OF THE PREFERRED EMBODIMENTS

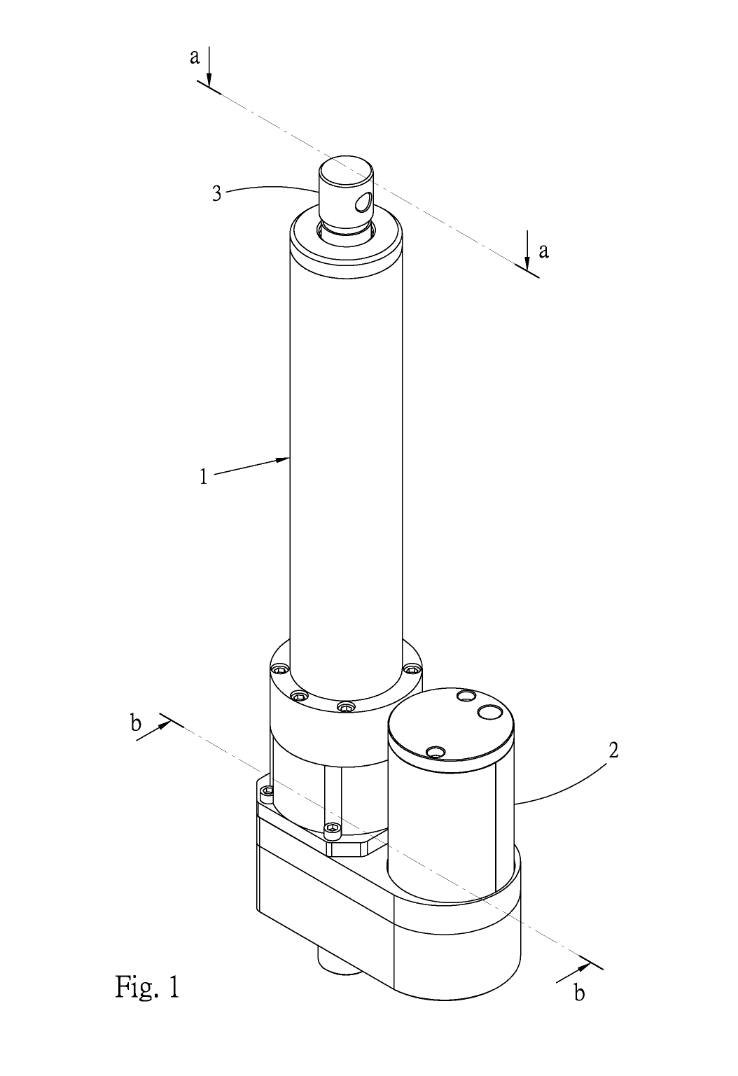

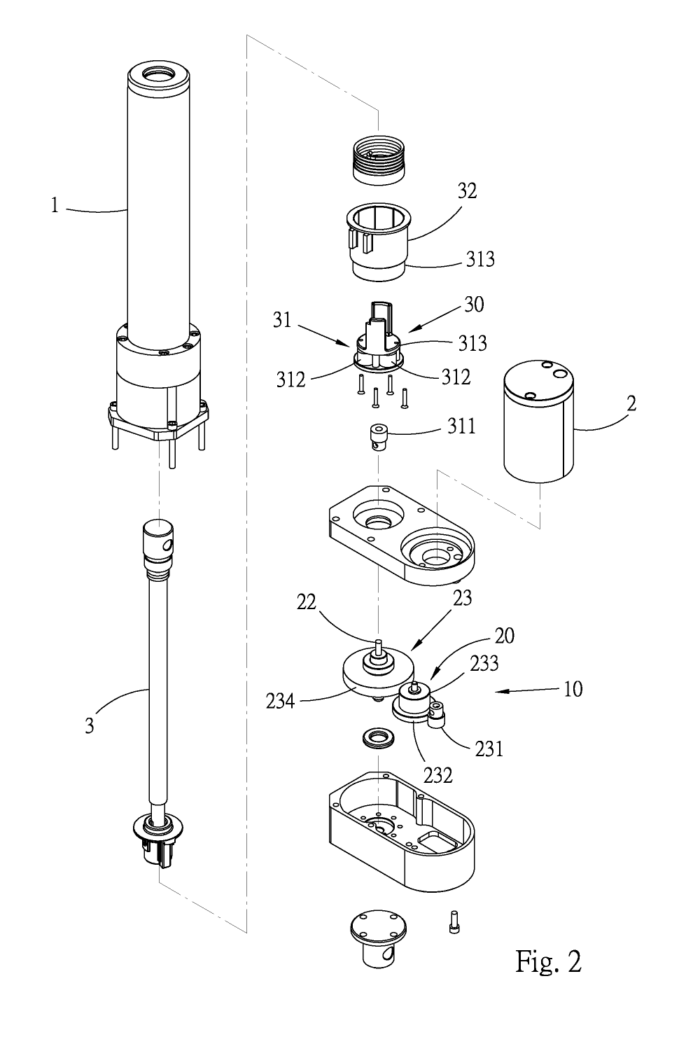

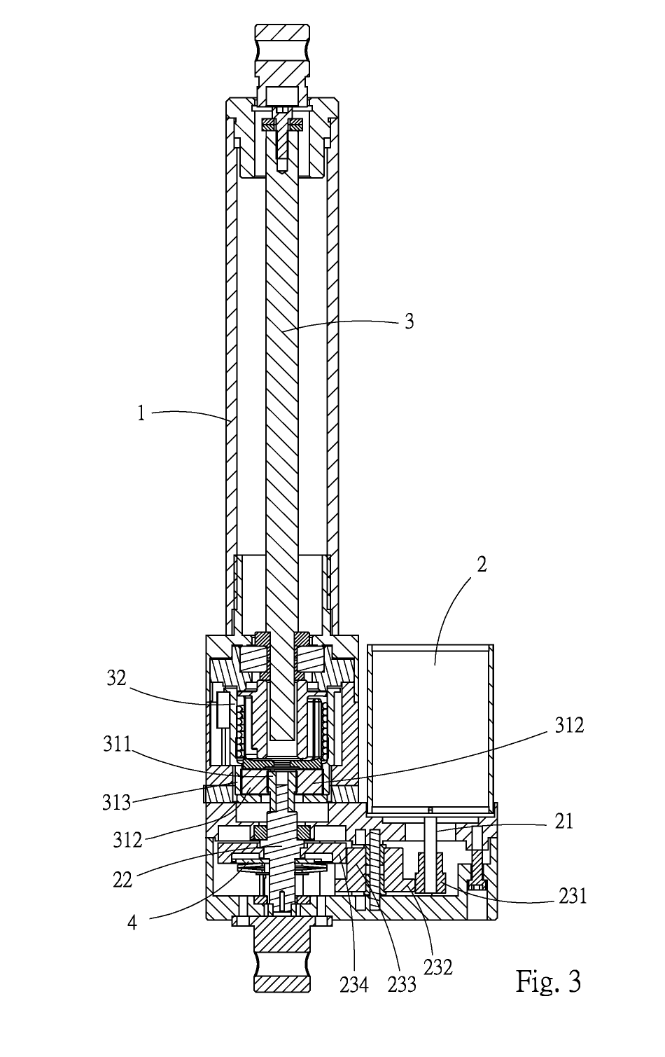

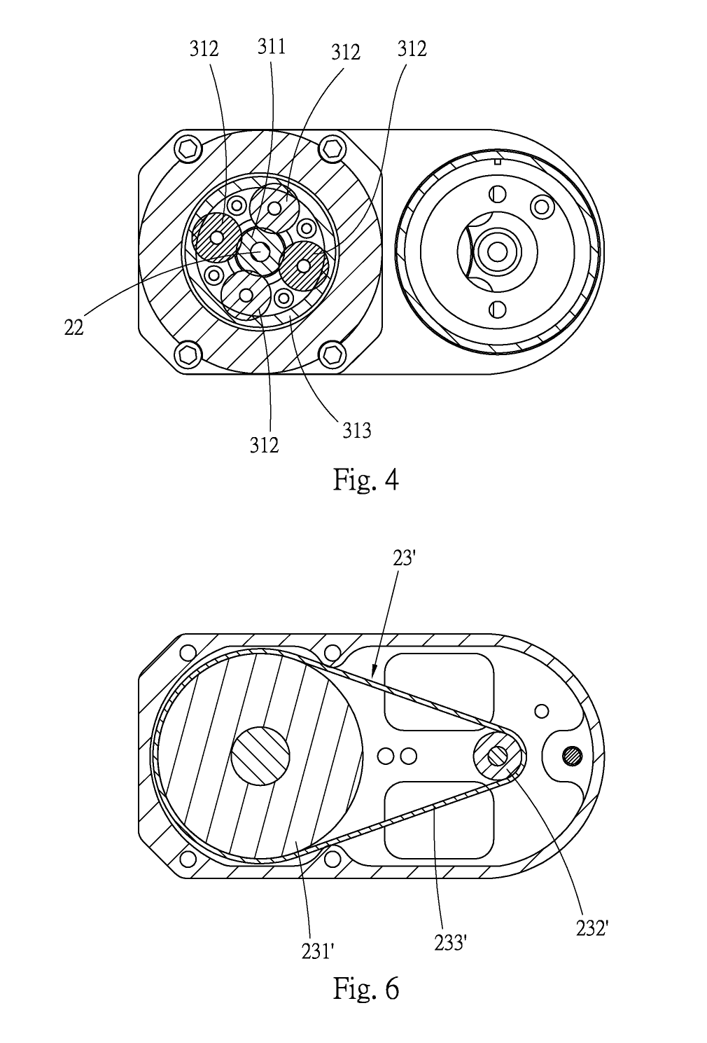

Please refer to FIGS. 1 to 4. According to a first embodiment, the complex reduction mechanism 10 of linear actuator of the present invention is installed in the linear actuator 1 as a component thereof. The complex reduction mechanism 10 is positioned between a power source 2 and an actuation shaft 3 of the linear actuator 1. The complex reduction mechanism 10 serves to reduce the rotational speed output from the power source 2 and transmits the power of the power source 2 to the actuation shaft 3 for driving the actuation shaft 3 at lower rotational speed and making the actuation shaft 3 linearly axially reciprocally move. To speak more specifically, the complex reduction mechanism 10 includes a primary reducing unit 20 and a secondary reducing unit 30.

The primary reducing unit 20 includes a primary input shaft 21, a primary output shaft 22 and a primary reducing set 23 positioned between the primary input shaft 21 and the primary output shaft 22. The primary reducing set 23 is composed of multiple forward gears. To speak more specifically, the primary input shaft 21 is coaxially coupled with a power output shaft of the power source 2 and rotationally drivable by the power source 2. The primary output shaft 22 is engaged with the primary reducing set 23 and positioned in parallel to the primary input shaft 21. The rotational speed of the primary input shaft 21 is reduced by the primary reducing set 23 and then the primary output shaft 22 transmits the power outward.

The primary reducing set 23 is composed of two sets of reducing gears. A first pinion shaft 231 is coupled with the primary input shaft 21 and a first gear shaft 232 is engaged with the first pinion shaft 21. A second pinion shaft 233 is coaxially fixedly coupled with the first gear shaft 232 and a second gear shaft 234 is engaged with the second pinion shaft 233. According to this arrangement, a desired reduction ratio is achievable by means of controlling the gear ratio of the gear shafts to the pinion shafts. In this case, the primary output shaft 22 coaxially coupled with the second gear shaft 234 can be driven at lower rotational speed. It should be noted that the primary output shaft 22 is coupled with the second gear shaft 234 via an overload protection device 4. Such overload protection device 4 pertains to prior art and thus will not be further described hereinafter.

The secondary reducing unit 30 is restrictedly arranged in an axial direction of the primary output shaft 22. The secondary reducing unit 30 includes a secondary reducing set 31 formed of a planetary gear train for further reducing the rotational speed transmitted from the primary output shaft 22. After the rotational speed is reduced by the secondary reducing set 31, a secondary output section 32 serves to transmit the power outward for driving the actuation shaft 3 to axially move.

To speak more specifically, the secondary reducing set 31 includes a sun gear 311 fixedly coupled with an end of the primary output shaft 22 and three planetary gears 312 engaged with the sun gear 3111 and located by a planetary carrier 313. The planetary gears 312 serve to transmit power to drive an internal ring gear 314 coaxial with the sun gear 311 and engaged with the planetary gears 312, whereby the internal ring gear 314 will rotate at an even lower rotational speed. The secondary output section 32 is a sleeve-like member coaxially connected onto the internal ring gear 314 to transmit power to the actuation shaft 3 via a conventional transmission technique to make the actuation shaft 3 axially move.

According to the above arrangement, the primary reducing unit 20 and the secondary reducing unit 30 of the complex reduction mechanism 10 of the present invention have more different gear ratios than the prior art to choose. Therefore, the present invention has more reduction ratio modes to meet actual requirements of the industrial fields. Accordingly, the load capability of the present invention can be adjusted as necessary. Moreover, as aforesaid, the secondary reducing unit 30 is restrictedly arranged in the axial direction of the primary output shaft 22. That is, the secondary reducing unit 30 is arranged between one end of the actuation shaft 3 and one end of the primary output shaft 22 and the secondary output section 32 is coaxial with the primary output shaft 22. In this case, the secondary reducing unit 30 is coaxially installed at the end of the actuation shaft 3 without increasing the total volume of the linear actuator 1. In the industrial fields, small volume means convenience and effectiveness in space utilization. Therefore, the complex reduction mechanism 10 of the present invention not only can provide more reduction ratio modes, but also can ensure the convenience in use of the linear actuator 1.

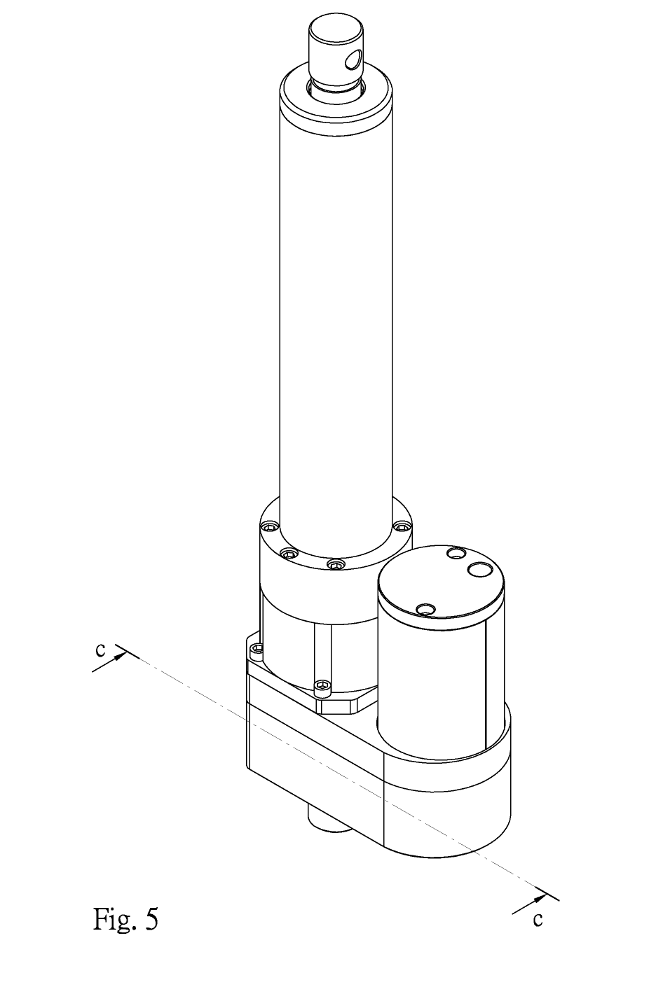

The above embodiment is only used to illustrate the present invention, not intended to limit the scope thereof. Many modifications of the above embodiment can be made without departing from the spirit of the present invention. For example, FIGS. 5 and 6 show a second embodiment of the complex reduction mechanism of the present invention. In this embodiment, the primary reducing set 23′ is composed of a large belt pulley 231′, a small belt pulley 232′ and a transmission belt 233′ for reducing transmission. Such technique is an equivalent of the first embodiment and included in the scope of the present invention. Also, the secondary reducing set is not limited to the planetary gear train of the first embodiment.

What is claimed is:

1. A complex reduction mechanism of linear actuator, which is installed in the linear actuator between a power source and an actuation shaft of the linear actuator, the complex reduction mechanism serving to reduce rotational speed output from the power source and transmit power of the power source to the actuation shaft for driving the actuation shaft to linearly axially move, the complex reduction mechanism comprising:
a primary reducing unit including a primary input shaft, a primary output shaft and a primary reducing set positioned between the primary input shaft and the primary output shaft, the primary input shaft being coupled with a power output shaft of the power source and rotationally drivable by the power source, whereby the primary input shaft can transmit rotational power to the primary reducing set, the primary reducing set serving to reduce the rotational speed and transmit the rotational power to the primary output shaft, whereby the primary output shaft can transmit the rotational power outward at lower rotational speed; and
a secondary reducing unit arranged in an axial direction of the primary output shaft, the secondary reducing unit including a secondary reducing set and a secondary output section, the secondary reducing set serving to further reduce the rotational speed output from the primary output shaft and transmit the rotational power to the secondary output section, whereby the second output section can transmit the rotational power at even lower rotational speed to the actuation shaft for driving the actuation shaft to linearly axially reciprocally move.

2. The complex reduction mechanism of the linear actuator as claimed in claim 1, wherein the primary output shaft of the primary reducing unit has an axis parallel to that of the primary input shaft of the primary reducing unit.

3. The complex reduction mechanism of the linear actuator as claimed in claim 1, wherein the secondary reducing unit is installed in the linear actuator and arranged between one end of the actuation shaft and one end of the primary output shaft.

4. The complex reduction mechanism of the linear actuator as claimed in claim 3, wherein the secondary output section of the secondary reducing unit is coaxial with the primary output shaft.

5. The complex reduction mechanism of the linear actuator as claimed in claim 4, wherein the secondary reducing set is a planetary gear train.

6. The complex reduction mechanism of the linear actuator as claimed in claim 5, wherein the secondary reducing set includes a sun gear coupled with the primary output shaft of the primary reducing unit.

7. The complex reduction mechanism of the linear actuator as claimed in claim 1, wherein the secondary reducing set is a planetary gear train.

8. The complex reduction mechanism of the linear actuator as claimed in claim 7, wherein the secondary reducing set includes a sun gear coupled with the primary output shaft of the primary reducing unit.
